(19) United States
(12) Patent Application Publication
(10) Pub. No.: US 2024/0289252 A1
(43) Pub. Date: Aug. 29, 2024

(54) DEFERRED CREATION OF REMOTE DEBUGGING SESSIONS

(71) Applicant: GM Cruise Holdings LLC, San Francisco, CA (US)

(72) Inventors: Stephen James Day, Kirkland, WA (US); Matt Landis, Bothell, WA (US); Ian Chiles, Charleston, SC (US); Victor Robertson, San Francisco, CA (US); Akhil Acharya, Cambridge, MA (US); Troy Gibb, San Francisco, CA (US); Gonzalo Lucero, Bellevue, WA (US)

(73) Assignee: GM Cruise Holdings LLC, San Francisco, CA (US)

(21) Appl. No.: 18/175,414

(22) Filed: Feb. 27, 2023

(51) Int. Cl. G06F 11/36; G06F 16/955

(52) U.S. Cl. CPC G06F 11/362; G06F 11/3664; G06F 16/955

(57) ABSTRACT

Failures can occur when a software process is running, or when the software process is undergoing tests. A remote debugging session can be created to run and inspect the software process, so that a developer can fix the bug that caused a failure. Remote debugging sessions can consume valuable resources on cluster infrastructure. Debugging the failures can take up a significant amount of developer time. To alleviate some of these problems, a remote debugging session can be created on-demand at a later time when a developer is ready to start the remote debugging session. The deferred creation of the remote debugging session can be triggered by activating a uniform resource identifier that has information for creating the remote debugging session encoded therein. The resulting implementation makes it easy for a developer to create a remote debugging session, and resources can be allocated on an as-needed basis.

### BACKGROUND

### Technical field

The present disclosure generally relates to cluster infrastructure and, more specifically, to deferred creation of remote debugging sessions.

### Introduction

Cluster infrastructure can include hardware and software resources deployed to support systems with high availability, scalability, and performance. Systems can be deployed on the cluster infrastructure, and the cluster infrastructure enables the systems to service requests being made to the systems.

Autonomous vehicles (AVs), also known as self-driving cars, and driverless vehicles, may be vehicles that use multiple sensors to sense the environment and move without human input. Technology in AVs may enable vehicles to drive on roadways and to accurately and quickly perceive the vehicle's environment, including obstacles, signs, and traffic lights. AV technology may utilize geographical information and semantic objects (such as parking spots, lane boundaries, intersections, crosswalks, stop signs, and traffic lights) for facilitating vehicles in making driving decisions. The vehicles can be used to pick-up passengers and drive the passengers to selected destinations. The vehicles can also be used to pick-up packages and/or other goods and deliver the packages and/or goods to selected destinations.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an exemplary system environment that may be used to facilitate AV operations, according to some aspects of the disclosed technology;

FIG. 2 illustrates an exemplary system for remote debugging session management, according to some aspects of the disclosed technology;

FIG. 3 illustrates an exemplary process for activating a uniform resource identifier and translating the uniform resource identifier into one or more commands, according to some aspects of the disclosed technology;

FIG. 4 illustrates another exemplary process for activating a uniform resource identifier and translating the uniform resource identifier into one or more commands, according to some aspects of the disclosed technology;

FIG. 5 is a flow diagram illustrating a method for deferring creation of a debugging session, according to some aspects of the disclosed technology;

FIG. 6 is a flow diagram illustrating another method for deferring creation of a debugging session, according to some aspects of the disclosed technology; and

FIG. 7 illustrates an exemplary processor-based system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details that provide a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

### Overview

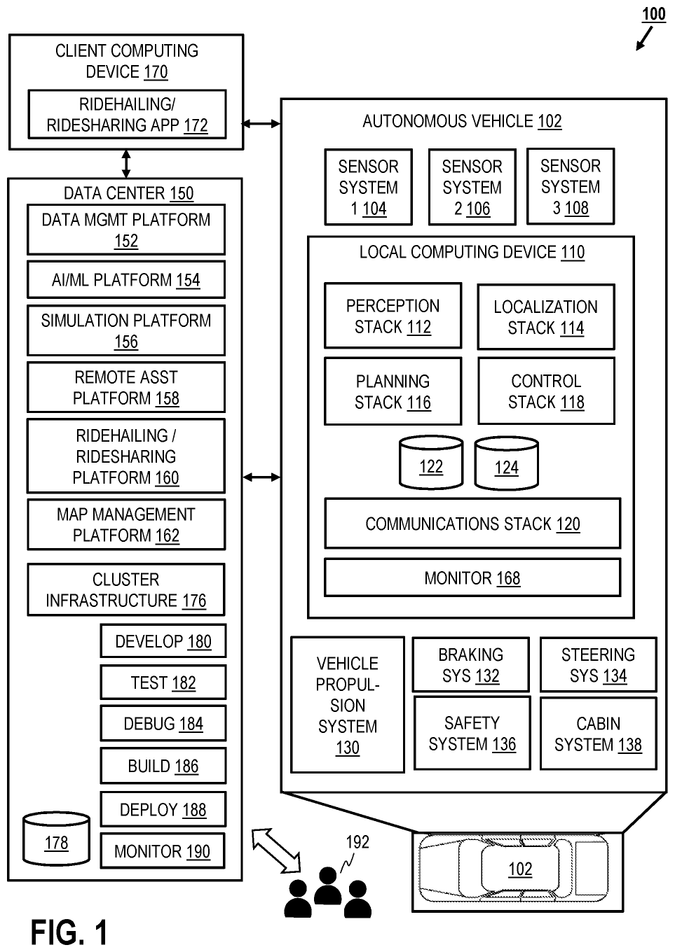

Applications that support operations of an autonomous vehicle fleet can be implemented on and supported by cluster infrastructure. Examples of such applications (and platforms) are described with FIG. 1. Many developers collaborate and write source code for these applications. Collaboration between developers and continuous integration of software can be enabled by tools that can be implemented on cluster infrastructure. Code repositories that allow collaboration between developers may be hosted on cluster infrastructure. Developers may use code editors or integrated development environments that are hosted on cluster infrastructure (as opposed to or in addition to running these developer tools locally on their machines). Build toolchains that compile source code and integrate builds into large software applications may be implemented on cluster infrastructure. Testing of software processes and builds may be implemented on cluster infrastructure. Monitoring of software processes and builds may be implemented on cluster infrastructure. Cost of having and maintaining cluster infrastructure can be high. It is not trivial to improve the developer experience while working on these applications and to efficiently utilize the resources on cluster infrastructure.

As used herein, a software process can encompass software, computer-implemented methods, computer-implemented programs, software builds, applications, platforms, operating systems, and systems that are deployed and are run/executed on hardware. Developers write source code and create builds that can be deployed onto hardware. A software process can cause hardware to perform functionalities and instructions encoded in the source code. Functionalities and instructions can include processing and manipulating data, receiving and outputting data, controlling hardware devices, etc.

Developers developing applications such as the applications described with FIG. 1 may be occupied with a variety of tasks, and may be performing under pressure to complete tasks timely and write code that is free of bugs. Debugging software processes remains an important task that takes up a significant portion of developer time, and can impact developer's ability to perform tasks on time. If developer experience for debugging software can improve, productivity of developers may also improve.

Failures can occur when a software process is running. These failures can include faults, such as segmentation faults, null pointer exceptions, and memory access violations. Failures can occur when the software process is undergoing tests, such as unit tests or integration tests. Outputs of the software process, or interactions between different software processes may fail to meet assertions of expected outputs or interactions. A remote debugging session can be created to run and inspect the software process, so that a developer can fix the bug that caused a failure.

Remote debugging sessions can consume valuable resources on cluster infrastructure. For example, whenever a failure occurs, resources may be held up to support a debugging session. A fixed set of resources may be allocated or dedicated solely for supporting remote debugging sessions.

Setting up a remote debugging session that has the same execution environment as the software process is not straight forward (and can be time consuming) for a developer, especially if the developer does not have visibility into how resources are configured and allocated in the cluster infrastructure or if the developer does not recall the specific tools or configurations that may be used for the software process right away. Also, the developer may not know where a core dump of the software process was saved.

Debugging the failures can take up a significant amount of developer time. Debugging certain difficult bugs can take more time than writing the source code that has the bug.

To alleviate some of these problems, a remote debugging session can be created on-demand at a later time when a developer is ready to start the remote debugging session. When a failure occurs, a monitoring application can save information that may be used for creating an appropriate or suitable remote debugging session. The information can then be encoded in a uniform resource identifier (URI) that can be activated at a later time. Until the URI is activated, resources may not be allocated for debugging. The URI can be sent to a developer (e.g., a device being used by the developer).

The deferred creation of the remote debugging session can be triggered by the developer activating the URI that has information for creating the remote debugging session encoded therein. For instance, the developer can click on a hyperlink that has the URI to activate the URI. In response to the URI being activated, a URI handler, that may be running on the device that the developer is using, can parse the URI and convert the URI into one or more commands that can be executed by an interface on the device. The interface can execute one or more commands and cause a remote debugging session to be created. Resources can then be allocated to support the remote debugging session.

The resulting implementation makes it easy for a developer to create a remote debugging session, and resources can be allocated on an as-needed basis.

### Systems for an AV Fleet Supported by Cluster Infrastructure

To better understand the varied systems that can be implemented on cluster infrastructure, FIG. 1 illustrates an exemplary system environment that may be used to facilitate AV operations, according to some aspects of the disclosed technology.

One of ordinary skill in the art will understand that, for the AV management system 100 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, a client computing device 170, devices used by developers 192. The AV 102, the data center 150, the client computing device 170, and devices used by developers 192 may communicate with one another over one or more networks.

AV 102 may navigate about roadways without a human driver based on sensor signals generated by multiple sensor systems 104, 106, and 108. The sensor systems 104-108 may include different types of sensors and may be arranged about the AV 102. For instance, the sensor systems 104-108 may comprise Inertial Measurement Units (IMUs), cameras (e.g., still image cameras, video cameras, etc.), light sensors (e.g., light detection and ranging (LIDAR) systems, ambient light sensors, infrared sensors, etc.), radio detection and ranging (RADAR) systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 may be a camera system, the sensor system 106 may be a LIDAR system, and the sensor system 108 may be a RADAR system. Other embodiments may include any other number and type of sensors.

AV 102 may also include several mechanical systems that may be used to maneuver or operate AV 102. For instance, the mechanical systems may include vehicle propulsion system 130, braking system 132, steering system 134, safety system 136, and cabin system 138, among other systems. Vehicle propulsion system 130 may include an electric motor, an internal combustion engine, or both. The braking system 132 may include an engine brake, a wheel braking system (e.g., a disc braking system that utilizes brake pads), hydraulics, actuators, and/or any other suitable componentry configured to assist in decelerating AV 102. The steering system 134 may include suitable componentry configured to control the direction of movement of the AV 102 during navigation. Safety system 136 may include lights and signal indicators, a parking brake, airbags, and so forth. The cabin system 138 may include cabin temperature control systems, in-cabin entertainment systems, and so forth. In some embodiments, the AV 102 may not include human driver actuators (e.g., steering wheel, handbrake, foot brake pedal, foot accelerator pedal, turn signal lever, window wipers, etc.) for controlling the AV 102. Instead, the cabin system 138 may include one or more client interfaces (e.g., GUIs, Voice User Interfaces (VUIs), etc.) for controlling certain aspects of the mechanical systems 130-138.

AV 102 may additionally include a local computing device 110 that is in communication with the sensor systems 104-108, the mechanical systems 130-138, the data center 150, and the client computing device 170, among other systems. The local computing device 110 may include one or more processors and memory, including instructions that may be executed by the one or more processors. The instructions may make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a planning stack 116, a control stack 118, a communications stack 120, an HD geospatial database 122, and an AV operational database 124, a monitor 168, among other stacks and systems. Collectively, a perception stack 112, a mapping and localization stack 114, a planning stack 116, a control stack 118 of the local computing device 110 may provide functionalities of an AV stack.

Perception stack 112 may enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 122, other components of the AV, and other data sources (e.g., the data center 150, the client computing device 170, third-party data sources, etc.). The perception stack 112 may detect and classify objects and determine their current and predicted locations, speeds, directions, and the like. In addition, the perception stack 112 may determine the free space around the AV 102 (e.g., to maintain a safe distance from other objects, change lanes, park the AV, etc.). The perception stack 112 may also identify environmental uncertainties, such as where to look for moving objects, flag areas that may be obscured or blocked from view, and so forth.

Mapping and localization stack 114 may determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 may compare sensor data captured in real-time by the sensor systems 104-108 to data in the HD geospatial database 122 to determine its precise (e.g., accurate to the order of a few centimeters or less) position and orientation. The AV 102 may focus its search based on sensor data from one or more first sensor systems (e.g., GPS) by matching sensor data from one or more second sensor systems (e.g., LIDAR). If the mapping and localization information from one system is unavailable, the AV 102 may use mapping and localization information from a redundant system and/or from remote data sources.

The planning stack 116 may determine how to maneuver or operate the AV 102 safely and efficiently in its environment. For example, the planning stack 116 may receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 102 from one point to another. The planning stack 116 may determine multiple sets of one or more mechanical operations that the AV 102 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 116 may select from multiple backup plans to carry out. For example, while preparing to change lanes to turn right at an intersection, another vehicle may aggressively cut into the destination lane, making the lane change unsafe. The planning stack 116 could have already determined an alternative plan for such an event, and upon its occurrence, help to direct the AV 102 to go around the block instead of blocking a current lane while waiting for an opening to change lanes.

The control stack 118 may manage the operation of the vehicle propulsion system 130, the braking system 132, the steering system 134, the safety system 136, and the cabin system 138. The control stack 118 may receive sensor signals from the sensor systems 104-108 as well as communicate with other stacks or components of the local computing device 110 or a remote system (e.g., the data center 150) to effectuate the operation of the AV 102. For example, the control stack 118 may implement the final path or actions from the multiple paths or actions provided by the planning stack 116. The implementation may involve turning the routes and decisions (e.g., a trajectory) from the planning stack 116 into commands for the actuators that control the AV's steering, throttle, brake, and drive unit.

The communication stack 120 may transmit and receive signals between the various stacks and other components of the AV 102 and between the AV 102, the data center 150, the client computing device 170, and other remote systems. The communication stack 120 may enable the local computing device 110 to exchange information remotely over a network. The communication stack 120 may also facilitate local exchange of information, such as through a wired connection or a local wireless connection.

The HD geospatial database 122 may store HD maps and related data of the streets upon which the AV 102 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left-turn lanes; permissive, protected/permissive, or protected only U-turn lanes; permissive or protected only right-turn lanes; etc.). The traffic controls layer may include geospatial information of traffic signal lights, traffic signs, and other road objects and related attributes.

The AV operational database 124 may store raw AV data generated by the sensor systems 104-108 and other components of the AV 102 and/or data received by the AV 102 from remote systems (e.g., the data center 150, the client computing device 170, etc.). In some embodiments, the raw AV data may include HD LIDAR point cloud data, image or video data, RADAR data, GPS data, and other sensor data that the data center 150 may use for creating or updating AV geospatial data.

In some cases, local computing device 110 may include monitor 168 (or monitor application). Monitor 168 may monitor for failures that may occur within components on local computing device 110 such as, perception stack 112, mapping and localization stack 114, planning stack 116, control stack 118, and communications stack 120. Monitor 168 may, in response to detecting a failure, save a core dump (or dump core) associated with local computing device 110, and other information that may be used to create a suitable remote debugging session.

A core dump may be referred to as memory dump, crash dump, storage dump, system dump. A core dump may include the recorded state of the working memory of a software process at a specific time, e.g., when the software process has encountered a failure (e.g., the software process has crashed or otherwise terminated abnormally. In some cases, other pieces of program state can be dumped at the same time, including the processor registers, which may include the program counter and stack pointer, memory management information, and other processor and operating system flags and information.

The data center 150 may send and receive various signals to and from the AV 102 and the client computing device 170. These signals may include sensor data captured by the sensor systems 104-108, roadside assistance requests, software updates, ridesharing pick-up and drop-off instructions, and so forth.

In this example, the data center 150 includes one or more of a data management platform 152, an Artificial Intelligence/Machine-Learning (AI/ML) platform 154, a simulation platform 156, a remote assistance platform 158, a ridehailing/ridesharing platform 160, and a map management platform 162, among other systems. These platforms may support operations of a fleet of AVs like AV 102. Many of these applications/platforms can be implemented on and supported by cluster infrastructure 176 of data center 150. In some cases, there may be multiple data centers, like data center 150, in different geographical locations, which would support these applications/platforms.

Data center 150 may include cluster infrastructure 176. Cluster infrastructure 176 may include hardware resources and software resources. Hardware resources can include computing/processing resources, data storage resources, network resources, etc. Examples of computing/processing resources may include machine-learning processors (e.g., machine-learning accelerators or neural processing unit), central processing units (CPUs), graphics processing units (GPUs), quantum computers, etc. Examples of data storage resources may include disk storage devices, memory storage devices, database servers, etc. Network resources may include network appliances (e.g., switches, routers, etc.), network connections, interconnects, etc. Software resources may include firmware for the hardware resources, operating systems for the hardware resources, virtual machines running on the hardware resources, software that manage the hardware resources, etc. Cluster infrastructure 176 may include resources managed by one or more providers.

In some cases, cluster infrastructure 176 may include one or more clusters. A cluster operator may define and provision resources in a cluster using a suitable infrastructure manager through machine-readable definition files. Applications (and services) can be deployed onto a cluster using application orchestration (e.g., deploy 188 of FIG. 1). Application orchestration can orchestrate deployment, maintenance, and scaling of applications on the resources in a cluster. Application orchestration can implement a control plane in the cluster that may service requests for application deployment and requests for maintaining applications running on the cluster. In some embodiments, a control plane may include persistent, lightweight, distributed key-value data store to store configuration data of the cluster, an application programming interface, a scheduler to assign unscheduled applications to a specific resource in the cluster, one or more controllers/operators each having a reconciliation loop, and a controller manager that manages the one or more controllers/operators. The control plane may orchestrate applications onto resources in the cluster, which may be organized and managed by the control plane using nodes and optionally node pools.

A cluster may have one or more nodes. A node (also called a worker) may be a resource on which an application (e.g., systems, services, workloads, etc.) can be deployed. A node may include a virtual or physical machine. Virtual machines are machines that emulate physical machines and are implemented on physical hardware. A node has a corresponding configuration. The configuration may include properties such as a machine type, a resource type, a specific operating system image, a minimum computing platform, amount of allocable data and/or computing resources for the node (also referred to as a shape of a node), a specific network interface, maximum number of applications that can run on the node, etc. The health/status of the node may be managed by the control plane. A node pool (also called a worker pool) may be a group of nodes within a cluster that all have the same configuration. A cluster may have one or more node pools.

An application, e.g., a unit that can be handled by the scheduler in the control plane is referred to herein as a pod. A pod may include a containerized application. The scheduler may schedule and deploy pods to nodes or node pools based on the configurations and health/state of the nodes or node pools. The control plane may schedule and deploy one or more pods on a given node. In some cases, a pod deployed on a node may be referred to as a worker. Pods deployed on node pools may be referred to as workers in a worker pool.

The data center 150 having cluster infrastructure 176 may be a private cloud (e.g., an enterprise network, a co-location provider network, etc.), a public cloud (e.g., an infrastructure as a service (IaaS) network, a platform as a service (PaaS) network, a software as a service (SaaS) network, or other communication service provider (CSP) network), a hybrid cloud, a multi-cloud, and so forth. The data center 150 may include cluster infrastructure 176, which can include hardware and software resources remote to the local computing device 110 for managing a fleet of AVs and AV-related services. For example, in addition to managing the AV 102, the data center 150 may also support a ridehailing/ridesharing service, a delivery service, a remote/roadside assistance service, street services (e.g., street mapping, street patrol, street cleaning, street metering, parking reservation, etc.), sensor calibration, and the like.

Data management platform 152 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 may access data stored by the data management platform 152 to provide their respective services.

The AI/ML platform 154 may provide the systems for training and evaluating machine-learning algorithms for operating the AV 102 (e.g., machine-learning models used in the AV stack), the simulation platform 156, the remote assistance platform 158, the ridehailing/ridesharing platform 160, the map management platform 162, and other platforms and systems. Using the AI/ML platform 154, data scientists may prepare data sets from the data management platform 152; select, design, and train machine-learning models; evaluate, refine, and deploy the models; maintain, monitor, and retrain the models; and so on.

The simulation platform 156 may simulate (or mimic) and/or augment real-world conditions (e.g., roads, lanes, buildings, obstacles, other traffic participants (e.g., other vehicles, cyclists, and pedestrians), trees, lighting conditions, weather conditions, etc.) so that the AV stack of an AV may be tested in a virtual environment that is similar to a real physical world. The simulation platform 156 may create a virtual environment that emulates physics of the real-world and sensors of an AV. Testing and evaluating AVs in simulation platform 156 can be more efficient and allow for creation of specific traffic scenarios that may occur rarely in the real-world. Moreover, the AV stack can even be tested in thousands of scenarios in parallel in simulation. More specifically, the AV stack may be executed in a simulator simulating various traffic scenarios at a time. With simulation platform 156, the AV stack implementing the perception, prediction, planning, and control algorithms can be developed, evaluated, validated, and fine-tuned in a simulation environment. The simulation platform 156 can also be used to evaluate only a portion of the AV stack.

The remote assistance platform 158 may generate and transmit instructions to control the operation of the AV 102. For example, in response to active trigger(s) being detected by the local computing device 110 on the AV 102, the remote assistance platform 158 may respond by creating a remote assistance session with a remote assistance operator to assist the AV 102. The remote assistance platform 158 may, with assistance from the remote assistance operator, generate and transmit instructions to the AV 102 to cause the AV 102 to perform a special driving maneuver (e.g., to drive AV 102 in reverse). The remote assistance platform 158 may utilize the remote assistance session to communicate with a customer in the AV 102 via the client computing device 170 to resolve concerns of the customer.

The ridehailing/ridesharing platform 160 (e.g., a web application) may interact with a customer of a ridehailing/ridesharing service via a ridehailing/ridesharing application 172 executing on the client computing device 170. Ridehailing/ridesharing platform 160 may provide delivery services as well. The client computing device 170 may be any type of computing system, including a server, desktop computer, laptop, tablet, smartphone, smart wearable device, gaming system, or other general-purpose computing device for accessing the ridehailing/ridesharing application 172. The client computing device 170 may be a customer's mobile computing device or a computing device integrated with the AV 102 (e.g., the local computing device 110). The ridehailing/ridesharing platform 160 may receive requests to be picked up or dropped off from the ridehailing/ridesharing application 172, and dispatch the AV 102 for the trip. A similar platform can be provided for delivery services.

Map management platform 162 may provide a set of tools for the manipulation and management of geographic and spatial (geospatial) and related attribute data. The data management platform 152 may receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data may be processed, and map management platform 162 may render base representations (e.g., tiles (2D), bounding volumes (3D), etc.) of the AV geospatial data to enable users to view, query, label, edit, and otherwise interact with the data. Map management platform 162 may manage workflows and tasks for operating on the AV geospatial data. Map management platform 162 may control access to the AV geospatial data, including granting or limiting access to the AV geospatial data based on user-based, role-based, group-based, task-based, and other attribute-based access control mechanisms. Map management platform 162 may provide version control for the AV geospatial data, such as to track specific changes that (human or machine) map editors have made to the data and to revert changes when necessary. Map management platform 162 may administer release management of the AV geospatial data, including distributing suitable iterations of the data to different users, computing devices, AVs, and other consumers of HD maps. Map management platform 162 may provide analytics regarding the AV geospatial data and related data, such as to generate insights relating to the throughput and quality of mapping tasks.

Developers 192 may develop one or more applications or software processes illustrated in FIG. 1. Developers 192 may develop code for platforms such as, data management platform 152, AI/ML platform 154, simulation platform 156, remote assistance platform 158, ridehailing/ridesharing platform 160, and map management platform 162. Developers 192 may develop code for perception stack 112, mapping and localization stack 114, planning stack 116, control stack 118, and communications stack 120. Developers 192 may develop code for ridehailing/ridesharing application 172. Developers 192 may use tools implemented on data center 150 (e.g., hosted/supported by cluster infrastructure 176) to collaborate with each other, and to work towards testing, building, deploying, and monitoring quality software. Illustrative tools that can be hosted/supported by cluster infrastructure 176 are shown as repository 178, develop 180, test 182, debug 184, build 186, deploy 188, and monitor 190. The functionalities of the tools may be accessible by developers 192 remotely via devices used by the developers 192. One or more of the tools can, in some cases, be implemented locally on devices used by the developers 192.

Repository 178 may be a code repository. There may be one or more repositories similar to repository 178 on data center 150. Repository 178 may include storage to store source code. Repository 178 may include storage to store tests. Repository 178 may include version control. Developers 192 may use a branch to isolate development work without affecting other branches in the repository 178. Repository 178 may have a default branch and can have multiple other branches. Developers 192 may merge a branch into another branch using a pull request. Developers 192 may create a fork, which can be a copy of a repository 178. A fork may allow developers 192 to make changes to the fork without affecting the repository 178. Updates from repository 178 can be fetched with pull requests. Changes to repository 178 can be submitted with pull requests. Repository 178 may include distributed version control. Repository 178 may implement one or more other functionalities such as access control, bug tracking, software feature request, task management, continuous integration, and documentation management.

Develop 180 may include a code editor, which can include a graphical user interface for developers 192 to visually read and see source code being written. Developers 192 can use a code editor as a user interface to type/write, format, and review source code. Develop 180 may include an integrated development environment (IDE), which can include one or more of: a code editor, build tools, and a debugger. An IDE may, in some cases, include one or more of: a compiler, an interpreter, a version control system, a class browser, an object browser, etc.

Test 182 may include engines to perform unit tests. Performing unit tests may include running software processes and checking outputs of the software processes against assertions of expected outputs. Test 182 may provide functionalities to allow developers 192 to author and save unit tests. Test 182 may provide functionalities to allow developers 192 to receive and view results of performing the unit tests (e.g., success, failures, pass-rates, flake rates, etc.) Test 182 may include engines to perform integration tests. Performing integration tests may include testing interactions between different software processes (e.g., components of a larger software system) to determine whether the interactions meet asserted expected interactions. In some cases, performing integration tests may include integrating software processes (e.g., components of a larger software system) logically and testing them as a group. Test 182 may include engines to perform build verification tests. Performing build verification tests may include verifying (core) functionalities of new builds or daily builds.

Debug 184 may include a debugger. A debugger may run and test a software process, and may expose information of the software process and the computing environment in which the software process is running on to allow developers 192 to pinpoint a cause for a failure. A debugger may run the software process under controlled conditions that allow developers 192 to track the execution of the software process and monitor changes in resources in the computing environment. A debugger may allow loading of a core dump. A debugger may allow the developers 192 to halt the software process at specific points (e.g., at a specified line number in the code), and display content of memory, processor registers, storage devices, etc.

Build 186 may include one or more build tools for building and testing software processes. A tool may convert source code files into software artifacts (e.g., images, executables, binaries, etc.) that can be run on a processor. The tool may compile the source code, and coordinate integration of reference source code libraries. The tool may perform static code/program analysis to determine whether developers 192 has adhered to certain levels of code quality. Build 186 may include one or more build toolchains. A build toolchain has a combination of different (specialized) build tools. The different build tools may be configured to work on different target hardware platforms (e.g., types of processors or system configurations). The different build tools may be specialized for certain build functions such as parsing, checking, compiling, linking, configuring, packaging, and deploying the software processes onto the target hardware.

Deploy 188 may include software and systems that deploys software builds and updates to a fleet of A Vs such as AV 102. Deploy 188 may include software and systems that deploys software builds and provides updates to many client computing devices such as client computing device 170. Deploy 188 may include software that works with cluster infrastructure 176 to deploy and maintain systems, services, and platforms (sometimes referred to as applications or software processes) running on the cluster infrastructure 176. Deploy 188 may allow users of cluster infrastructure 176 (e.g., developers 192) to configure, deploy, coordinate, and manage applications on cluster infrastructure 176. In some cases, deploy 188 may provide resource usage optimization, achieve certain quality of service parameters, and load balancing of the applications on cluster infrastructure 176. While not required, applications deployed on cluster infrastructure 176 can be containers (or containerized applications). A container means that the code and dependencies are packaged as a unit or image (e.g., having code, runtime, system tools, system libraries and settings) in such a way that the application can be created and run quickly on cluster infrastructure 176 regardless of the underlying cluster infrastructure environment.

Monitor 190 may be similar to monitor 168, but different in that monitor 190 may monitor for failures in software processes, applications, and platforms that are operating on cluster infrastructure 176. Monitor 190 may determine and save information suitable for creating a suitable debugging session at a later time. Monitor 190 may dump core or save a core dump if a software process running on a certain execution environment on cluster infrastructure 176 encounters a failure. If an application is containerized, the core dump may include information relating to the execution environment of the containerized application (e.g., the configuration of the container). The information relating to the execution environment may include information that specifies an operating system for executing a software process (e.g., an image that can be deployed onto cluster infrastructure 176 to spawn new workers). The information relating to the execution environment may include information that specifies a software development kit (SDK) suitable for manipulating with the software process on the operating system.

In some embodiments, developers 192 may perform various developer tasks and interact with systems such as repository 178, develop 180, test 182, debug 184, build 186, deploy 188, and monitor 190, through workspaces. A workspace may be an environment in which a developer works to develop, test, and build code. A workspace can host source code, tools, and configurations to allow a developer to work on the source code. A workspace can include a debugger to allow a developer to debug a failure. A developer may create one or more workspaces to switch between different tasks or projects. For a remotely hosted workspace, resources on cluster infrastructure 176 may be allocated to support the workspace. For a locally-hosted workspace, resources on a computing device used by the developer (e.g., a laptop or desktop) may be allocated to support the workspace. For example, resources may be allocated to run the software process, provide tools, and provide resources according to the configurations. A workspace may include an execution environment for the software process that a developer is developing. A workspace may host the source code that a developer is writing. A workspace may host tool(s) used by the developer to write and compile source code. A workspace may have configurations (e.g., configurations for an IDE, an SDK, and an operating system) that are specific to the workspace. Remote workspaces can be launched on cluster infrastructure 176 and accessed via computing devices used by the developers 192 (e.g., through a shell). Local workspaces can also be created directly on the computing devices used by the developers 192 (e.g., through a local terminal).

### Exemplary Remote Debugging Session Management System

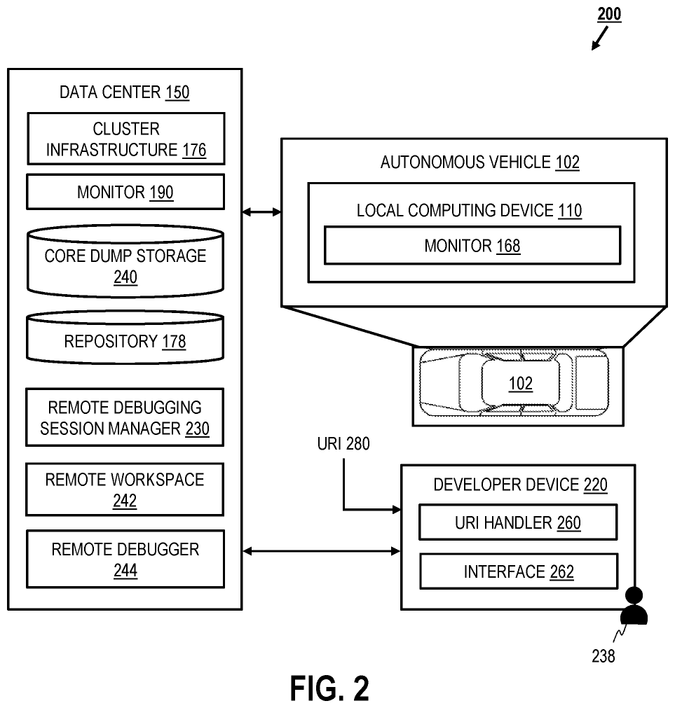

FIG. 2 illustrates an exemplary system for remote debugging session management, according to some aspects of the disclosed technology. The system 200 includes an AV 102, a data center 150, and a developer device 220 (e.g., a computer used by a developer 238). The AV 102, the data center 150, and the developer device 220, may communicate with one another over one or more networks. Although not shown explicitly in FIG. 2, cluster infrastructure 176 may be executing software processes such as applications/platforms illustrated in FIG. 1, and AV 102 may be executing software processes such as the AV stack illustrated in FIG. 1.

Data center 150 may include core dump storage 240, repository 178, remote debugging session manager 230, a remote workspace 242, and a remote debugger 244.

Developer device 220 may be used by developer 238. Developer device 220 may include a URI handler 260, and interface 262. Developer 238 may use interface 262, as a unified entry point, or entry point, to create and work within workspaces. Developer 238 may use interface 262 to write source code, and perform other developer tasks. Interface 262 may receive input from developer 238 as developer 238 perform various developer tasks, and based on the input, interact with components in data center 150. Interface 262 may send commands to components in data center 150 to open a pull request, deploy applications, schedule software builds, initiate unit testing, etc. Interface 262 may send commands to components in data center 150, such as remote debug session manager 230, to create workspaces. Herein, interface 262 is called “entry”. Interface 262 may include a terminal. Interface 262 may include a command line interface. Interface 262 may include a graphical user interface.

As discussed with FIG. 1, monitor 190 and monitor 168 may dump core and save a core dump upon detecting a failure in a software process. For example, if a failure is detected for a software process running on cluster infrastructure 176, monitor 190 may dump core and save a core dump at a specific location in cloud storage, such as core dump storage 240. In another example, if a failure is detected for a software process running on local computing device 110, monitor 168 may dump core and save a core dump at a specific location in cloud storage, such as core dump storage 240. In some cases, if a developer is running software processes locally, a monitor (though not shown), similar to monitor 190 and monitor 168, may be provided on developer device 220.

Core dump storage 240 may provide object storage (e.g., storage of unstructured data) where data such as core dumps can be stored in certain buckets or locations. For a given bucket/location, many objects (i.e., units of unstructured data) can be uploaded to, stored in, maintained in, and retrieved from the bucket/location. Core dumps can be saved in core dump storage 240 when failures occur.

Instead of creating a remote debugging session immediately upon detecting a failure, which can hold up expensive resources on cluster infrastructure 176, monitor 190 and/or monitor 168 may instead determine and gather information which can enable a remote debugging session to be created at a later time.

Monitor 190 and/or monitor 168 may, in response to a failure being detected for a software process, determine information relating to the software process encountering the failure. The information being determined and gathered can ensure that a proper or appropriate debugging session can be created to debug the causes of the failure. A debugging session preferably has information about the workspace suitable to debug the specific software process (so that the debugging session can recreate the execution environment), and information for where the core dump is stored (so that the debugging session can obtain and load the core dump).

The information relating to a software process can include information specifying a workspace that is to be used for debugging the software process. The information specifying a workspace can encompass, e.g., information about the execution environment of the software process, a line number of the source code where the failure occurred, information about tools that can be used for debugging the software process, location of the core dump, and parameter(s) suitable for restarting the software process for debugging purposes. The information may be saved in a file (e.g., an event log file). The information may be saved as a debug-information file.

The information specifying the workspace can include information identifying a repository storing source code of the software process. This information identifying a repository can include a path (or name/identifier/locator) to a repository (e.g., identifying a specific branch or fork of the repository) such as repository 178. The path may specify a specific feature of the repository. The path may specify a version of the feature of the repository.

The information specifying the workspace can include information regarding a computing environment executing the software process. Examples of such information regarding the computing environment can include: identifying information for tools that can manipulate the source code of the software process, identifying information for tools that can run the software process, identifying information for an operating system that is able to execute the software process, identifying information for an IDE or SDK that can allow developer 238 to manipulate and test the source code, etc.

The information specifying the workspace may include a unique identifier or name that can be attached to the workspace. Monitor 190 and monitor 168 may generate assign a unique identifier or name for the workspace to be created. The identifier may encode timestamp information associated with the failure. The identifier may encode information about the type of failure. The name may (uniquely) identify the workspace that can be created to debug the failure.

In some cases, if different types/kinds of workspaces are organized as a list of unique identifiers or names (and can be referenced by the identifier/name), information specifying the workspace can include the unique identifier or name assigned to the workspace.

The information relating to the software process may include a storage location in which a core dump of an environment executing the software process is stored. This information identifying a core dump can include a path to a bucket/location in which the core dump is stored, such as a path to a bucket/location in core dump storage 240. An example of a path is, “storage://debug-bucket/coredump”.

The information relating to the software process may include an identifier for the action/request which committed the source code of the software process. The information relating to the software process may include the type of failure that occurred. The information relating to the software process may include a line number of the source code at which the failure occurred.

In some embodiments, monitor 190 and/or monitor 168 may create a string, e.g., sequence of characters. The string may encode the information relating to the software process. In some cases, remote debugging session manager 230 may receive the information relating to the software process from monitor 190 and/or monitor 168, and create the string. The string can identify resources that may be used to create a debugging session. The string may be referred to as a URI. The URI may encode one or more values or pieces of information. The URI may encode one or more attribute-value pairs. The URI may encode one or more arrays. The URI may include the information relating to the software process in a serialized form. To create the string, information relating to the software process (and optionally other information that may specify a suitable workspace to be created) can be transformed or serialized into a URI. The URI can encode information for creating the debugging session in a string format.

One example of the string may be:

entry://workspace/create?repo=repo-with-fault&exec=“remote-debug start storage://debug-bucket/coredump” &name=debug-session

The string may identify interface 262, e.g., “entry”. The string may identify information for creating a workspace that can debug the software process, such as instructions for creating the workspace, parameters for the workspace, etc. The information for creating the workspace may include the information identifying a repository storing source code of the software process, “repo=repo-with-fault”. The string may include a command (or a portion of a command) for creating and running the debugging session within the workspace, e.g., “&exec=”remote-debug start storage://debug-bucket/coredump“. The command may include a sub-command to run the debugging session within the workspace, e.g., “remote-debug”. The command may include a sub-command to load the core dump stored at the storage location into the workspace, e.g., “start storage://debug-bucket/coredump”. The command may include a sub-command to break the execution of the software process at a specific line number of the source code, e.g., the line number at which the failure occurred. The command may include parameters for the debugging session. The string may identify a name (or unique identifier) for the workspace to be created, e.g., “&name=debug-session”. The name may be used to delineate between different workspaces, or uniquely identify workspaces. The string may identify a location of a file that includes information for creating a workspace that can debug the software process and running a debugging session.

Once the string, or URI, is composed or created, the URI can be transmitted to a device, e.g., developer device 220 being used by developer 238. Developer device 220 may receive URI 280 (e.g., from monitor 190, monitor 168, or remote debugging session manager 230). At this point, resources may not have been consumed to support a remote debugging session.

Developer device 220 can include a URI handler 260 and interface 262. URI handler 260 may be implemented locally on developer device 220. In some cases, URI handler 260 may be implemented remotely from the developer device 220.

Developer device 220, e.g., URI handler 260 or interface 262, may receive the URI encoding information for creating a workspace and running a debugging session within the workspace. The debugging session can be used to debug a failure that occurred with a software process.

URI handler 260 may listen for user input from developer 238 that activates the URI. Developer 238 may click on a hyperlink having the URI to activate the URI. Developer device 220 may receive user input on developer device 220 selecting the URI. Developer 238 may receive the URI (e.g., the string) from developer 238 via a user interface (e.g., a browser or terminal). Developer 238 activating the URI indicates that a remote debugging session is to be created. Resources may be allocated to run the remote debugging session. The remote debugging session may include a remote workspace 242 and a remote debugger 244 attached to the software process within the remote workspace 242.

In response to the developer activating the URI, the URI handler 260 can process/parse the URI to extract values or information from the URI. The URI handler 260 can translate the values or information from the URI into one or more commands that can be run/executed in interface 262. If the URI has a pointer or path to a file with debugging information, the URI handler may 260 may fetch the file to obtain the values or information to be used to generate the one or more commands. The one or more commands can be input into the interface 262 and cause the one or more commands to be executed. Running/executing the one or more commands, the interface 262 can cause a workspace suitable for debugging the software process to be created and run the debugging session in the workspace using the information encoded in the URI.

Exemplary commands that can be executed via interface 262 are as follows:
>entry create debug-session repo-with-fault
>entry exec remote-debug start storage://debug-bucket/coredump

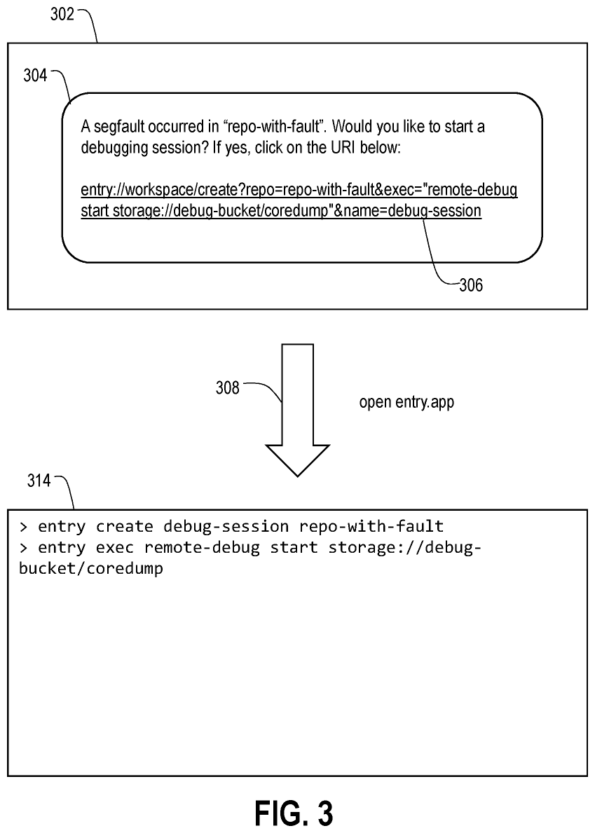

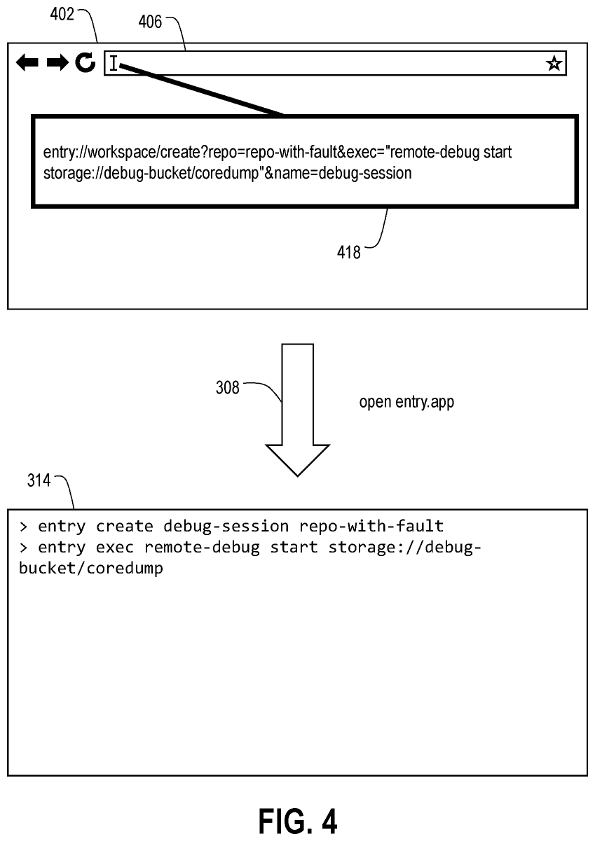

Additional details illustrating exemplary workflows with developer 238 are discussed with FIGS. 3-4.

In some embodiments, the remote debugging session manager 230 can receive and process the one or more commands and allocate resources to create the remote workspace 242 and the debugging session within the workspace. The remote debugging session manager 230 may receive from developer device 220 (e.g., via the interface 262) a first command for creating the workspace suitable for debugging the software process. The remote debugging session manager 230 may receive from developer device 220 (e.g., via the interface 262) a second command for starting and running the debugging session within the workspace.

Creation of a remote debugging session (and allocation of resources to support the remote debugging session) can be deferred until developer 238 activates the URI, so that resources on cluster infrastructure 176 are not held up unnecessarily. In response to receiving commands to create the workspace and to run the debugging session, remote debugging session manager 230 may allocate resources accordingly. Resources can be allocated to create remote workspace 242. Remote workspace 242 can be configured based on the commands executed via interface 262, so that remote workspace 242 is suitable for debugging the software process encountering a failure. Resources can be allocated to create and attach remote debugger 244 to the remote workspace 242. One or more workers on cluster infrastructure 176 may be allocated as resources to support the remote debugging session.

In response to receiving a command for creating the workspace from the developer device 220, remote debugging session manager 230 may allocate resources to check out and host the source code of the software process from repository 178. Remote debugging session manager 230 may perform one or more of the following: open a pull request with a branch in repository 178, create a branch of repository 178, create a new version of a feature within the repository 178, and create a copy of the source code from the repository 178.

In response to receiving a command for running the debugging session from the developer device 220, remote debugging session manager 230 may cause one or more workers in cluster infrastructure 176 in accordance with the workspace (e.g., remote workspace 242) to be allocated to run the software process, and cause the core dump to be loaded onto the one or more workers. The remote debugging session manager 230 may retrieve the core dump from core dump storage 240 using path information provided in the one or more commands (which may originate from the URI).

In response to receiving a command for running the debugging session from the developer device 220, remote debugging session manager 230 may cause resources to run a code editor to be allocated. Developer 238 may then access the code editor via interface 262 to review the source code. In response to the interface 262 executing the one or more commands to create the workspace and run a debugging session, the interface 262 may cause an output of developer device 220 to display a user interface of the code editor.

In response to receiving a command for running the debugging session from the developer device 220, remote debugging session manager 230 may cause resources to run a debugger (e.g., remote debugger 244) to be allocated. Remote debugging session manager 230 may attach the debugger to the resources running the software process to inspect the software process within the environment of the remote workspace 242. Developer 238 may then access the debugger via interface 262 to analyze the behavior of the software process that encountered the failure. In response to the interface 262 executing the one or more commands to create the workspace and run a debugging session, the interface 262 may cause an output of developer device 220 to display a user interface of the debugger. The user interface of the debugger may indicate a position in the source code (e.g., line number of the source code) where the failure occurred.

In some cases, remote debugging session manager 230 may manage a life cycle of the remote workspace 242 created for the remote debugging session. In some embodiments, remote debugging session manager 230 may report to developer 238, via interface 262 of developer device 220, a progress of allocating resources to support the remote workspace 242 and the remote debugger 244. For example, remote debugging session manager 230 may, in response to resources being successfully allocated to create the remote workspace 242 and run the debugging session, transmit a ready-status message to developer device 220. Developer device 220 (e.g., via interface 262) may receive the ready-status message indicating that resources have been successfully allocated for the workspace and to run the debugging session.

When developer 238 is finished with the debugging task, or wishes to pause the debugging task and resume the debugging task another time, developer 238 may delete the remote workspace 242 by running a command in interface 262 to delete the remote workspace 242. Via interface 262, developer device 220 may receive user input (e.g., a command) to delete the workspace and cause the resources allocated for the remote workspace 242 and the debugging session to be recycled. In response to receiving a command (e.g., via interface 262) from developer device 220 (e.g., input by developer 238) to delete the remote workspace 242, resources allocated to the remote workspace 242 and any other resources relating to the remote debugging session can be recycled. The resources can be freed up for other applications on cluster infrastructure 176.

While the embodiments described herein generally refer to deferred creation of remote debugging sessions, the various aspects of the present disclosure are applicable and usable for deferring creation of locally-hosted debugging sessions (sessions which are created and hosted directly on developer device 220) as well. It may be desirable to also prevent poor utilization of limited resources on developer device 220. The benefits such as the ease of being able to create a proper debugging session also extends to scenarios where developer 238 who wants to host the debugging session on developer device 220 instead. Functionalities provided by remote debugging session manager 230 may be implemented locally on developer device 220 instead to allocate local resources to support the workspace and debugger.

### Exemplary Processes for Creating a Remote Debugging Session Using the URI

FIG. 3 illustrates an exemplary process for activating a URI and translating the URI into one or more commands, according to some aspects of the disclosed technology.

User interface 302 illustrates a display to a developer (e.g., developer 238 of FIG. 2). User interface 302 may be provided on a computing device used by the developer (e.g., developer device 220 of FIG. 2). The user interface 302 may include a message 304 displayed to a user. The message may be displayed after a failure has been detected with a software process.

The message 304 may include an indication of a failure that occurred (e.g., a type of failure that occurred). The message 304 may identify a repository (e.g., a branch, a feature, a fork, etc.) storing the source code of the software process that encountered the failure. The message 304 may include a message asking if the developer wishes to create a remote debugging session.

If the developer wants to create a remote debugging session, the developer may click on a user interface element (e.g., hyperlink 306) to activate a URI. Selecting or activating the user interface element, e.g., the hyperlink 306 having URI, may cause the computing device to trigger a URI handler (e.g., URI handler 260 of FIG. 2) to process the URI. Selecting or activating the URI may cause the computing device to determine whether an interface (e.g., interface 262) is already running on the computing device. The interface is used for executing commands translated from the URI, so the computing device may determine whether the interface is already running on the computing device. In some embodiments, if the interface is not already running on the computing device, the interface (application) may be opened or run on the computing device.

Opening the interface (e.g., “entry.app”) on the computing device is illustrated by arrow 308. The URI handler may parse the URI to extract values or information that can be used to create a workspace and start a remote debugging session. The URI handler may use the values or information to generate one or more commands to be executed by the interface. In response to receiving the URI on the computing device, the interface suitable for executing the commands may be opened or run on the computing device.

User interface 314 illustrates a terminal display of the interface viewable and usable by the developer. The URI handler can translate the URI into commands, and the commands are entered into the interface for execution. As illustrated, the interface is executing a first command to create a workspace using source code from a repository (e.g., “entry create debug-session repo-with-fault”, and a second command to execute a remote debugging session using core dump stored in a core dump repository (e.g., “entry exec remote-debug start storage://debug-bucket/coredump”).

FIG. 4 illustrates another exemplary process for activating a URI and translating the URI into one or more commands, according to some aspects of the disclosed technology.

User interface 402 illustrates a display to a developer (e.g., developer 238 of FIG. 2). User interface 402 may be provided on a computing device used by the developer (e.g., developer device 220 of FIG. 2). The user interface 302 may be a display of a browser viewable and usable by the developer. The developer may input the URI 418 directly in an address bar 406 of the browser to indicate activation of the URI. The browser may detect that the URI is intended to be processed/parsed by a URI handler, and cause the URI handler to process the URI. The browser may trigger an interface (e.g., “entry.app”) that can execute commands translated from the URI to be run or executed on the computing device, if the interface is not already running on the computing device. Arrow 308 and user interface 314 may have features that are the same and/or similar to what is shown in FIG. 3.

As illustrated in FIGS. 3-4, a developer no longer has to know or specify the tools and configurations of the workspace that is to be created to debug the failure. Also, the developer does not need to know the location of the core dump. The information that is used to create the workspace and the remote debugging session have been encoded in the URI. The developer does not need to write and run commands to create the workspace and run the debugging session. A click on a user interface element or user input of the URI into a browser are examples of how a developer can trigger the creation of a suitable workspace and execution of a debugging session.

### Exemplary Methods for Deferring Creation of a Debugging Session

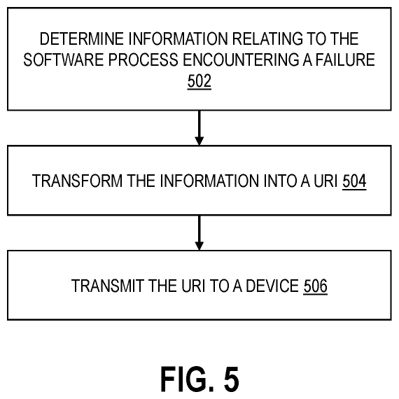

FIG. 5 is a flow diagram illustrating a method for deferring creation of a debugging session, according to some aspects of the disclosed technology. In 502, in response to a failure being detected for a software process, information relating to the software process encountering the failure may be determined. The information relating to the software process can include one or more of: information specifying a workspace that is to be used for debugging the software process, and a storage location in which a core dump of an environment executing the software process is stored. In 504, the information relating to the software process may be transformed into a URI. The URI can encode information for creating the debugging session in a string format. In 508, the URI may be transmitted to a device. The device can have a URI handler and an interface to create the workspace and run the debugging session using the information encoded in the URI.

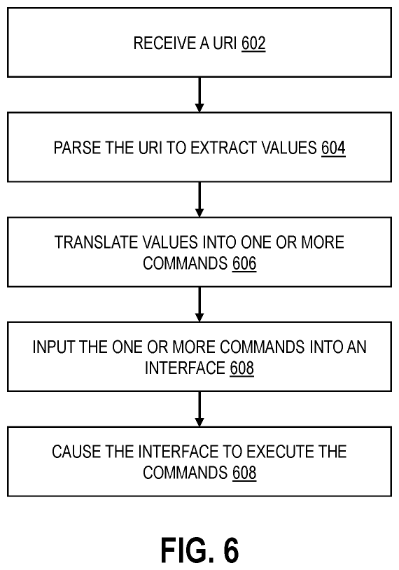

FIG. 6 is a flow diagram illustrating another method for deferring creation of a debugging session, according to some aspects of the disclosed technology. In 602, a device may receive a URI encoding information for creating a workspace and running a debugging session within the workspace to debug a failure that occurred with a software process. In 604, a URI handler may parse the uniform resource identifier to extract values. In 606, the URI handler may translate the values into one or more commands to create and run the debugging session. In 608, the URI handler may cause the one or more commands to be input into an interface. In 609, the URI handler may cause the interface to execute the one or more commands.

### Exemplary Processor-Based System

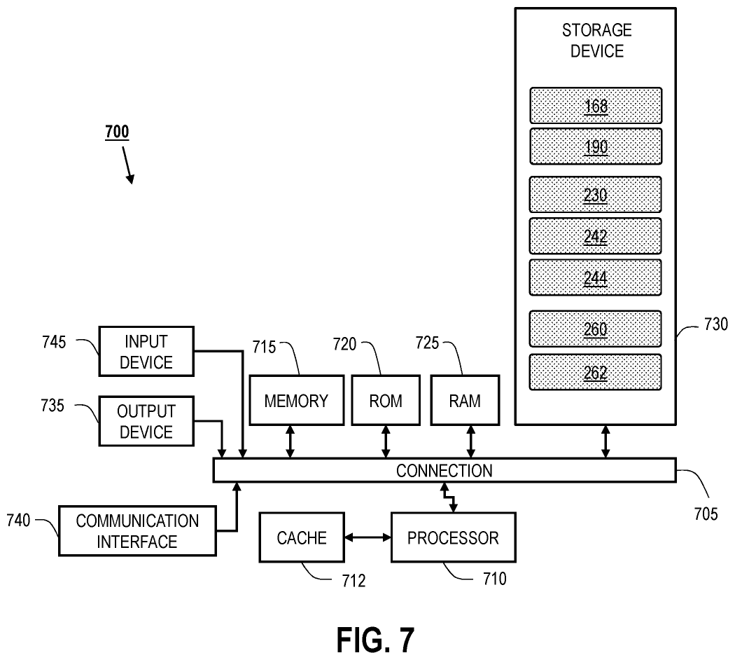

FIG. 7 illustrates an exemplary processor-based system with which some aspects of the subject technology may be implemented. For example, processor-based system 700 may be any computing device making up, or any component thereof in which the components of the system are in communication with each other using connection 705. Connection 705 may be a physical connection via a bus, or a direct connection into processor 710, such as in a chipset architecture. Connection 705 may also be a virtual connection, networked connection, or logical connection.

In some embodiments, computing system 700 can represent the local computing device 110 of FIG. 1. In some embodiments, computing system 700 can represent parts of cluster infrastructure 176 in data center 150 of FIG. 1. In some embodiments, computing system 700 can represent client computing device 170 of FIG. 1 In some embodiments, computing system 700 can represent developer device 220 of FIG. 1 In some embodiments, one or more of the described system components represents many such components each performing some or all of the function for which the component is described. In some embodiments, the components may be physical or virtual devices.

Exemplary system 700 includes at least one processing unit (e.g., a CPU or another suitable processor) 710 and connection 705 that couples various system components including system memory 715, such as Read-Only Memory (ROM) 720 and Random-Access Memory (RAM) 725 to processor 710. Computing system 700 may include a cache of high-speed memory 712 connected directly with, in close proximity to, or integrated as part of processor 710.

Processor 710 may include any general-purpose processor and a hardware service or software service, such as executable instructions that implement functionalities such as methods and processes described herein. The functionalities carried out by one or more of: monitor 168, monitor 190, remote debugging session manager 230, remote workspace 242, remote debugger 244, URI handler 260, and interface 262. Processor 710 may be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms known to those of skill in the art. In some instances, multimodal systems may enable a user to provide multiple types of input/output to communicate with computing system 700. Computing system 700 may include communications interface 740, which may generally govern and manage the user input and system output. The communication interface may perform or facilitate receipt and/or transmission of wired or wireless communications via wired and/or wireless transceivers.

Storage device 730 may be a non-volatile and/or non-transitory and/or computer-readable memory device and may be a hard disk or other types of computer-readable media which may store data that are accessible by a computer.

Storage device 730 may include software services, servers, services, etc., that when the code that defines such software is executed by the processor 710, cause the system 700 to perform a function. In some embodiments, a hardware service that performs a particular function may include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special-purpose computer, including the functional design of any special-purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

### Select Examples

Example 1 is a computer-implemented method for deferring creation of a debugging session, comprising: in response to a failure being detected for a software process, determining information relating to the software process encountering the failure, wherein the information relating to the software process includes: information specifying a workspace that is to be used for debugging the software process; and a storage location in which a core dump of an environment executing the software process is stored; transforming the information relating to the software process into a uniform resource identifier, wherein the uniform resource identifier encodes information for creating the debugging session in a string format; and transmitting the uniform resource identifier to a device, wherein the device has a uniform resource identifier handler and an interface to create the workspace and run the debugging session using the information encoded in the uniform resource identifier.

In Example 2, the computer-implemented method of Example 1 can optionally include the information specifying the workspace comprising: information identifying a repository storing source code of the software process.

In Example 3, the computer-implemented method of Example 1 or 2 can optionally include the information specifying the workspace comprising: information regarding a computing environment executing the software process.

In Example 4, the computer-implemented method of any one of Examples 1-3 can optionally include the information specifying the workspace comprising: name identifying the workspace.

In Example 5, the computer-implemented method of any one of Examples 1-4 can optionally include: the uniform resource identifier comprising information for creating the workspace; and the information for creating the workspace comprising information identifying a repository storing source code of the software process.

In Example 6, the computer-implemented method of any one of Examples 1-5 can optionally include the uniform resource identifier comprising: a command for running the debugging session within the workspace.

In Example 7, the computer-implemented method of Example 6 can optionally include the command comprising: a sub-command to run the debugging session within the workspace.

In Example 8, the computer-implemented method of Example 6 or 7 can optionally include the command comprising: a sub-command to load the core dump stored at the storage location into the workspace.

In Example 9, the computer-implemented method of any one of Examples 1-8 can optionally include the uniform resource identifier comprising: a name identifying the workspace.

In Example 10, the computer-implemented method of any one of Examples 1-9 can optionally include: receiving, from the device, a first command for creating the workspace; and receiving, from the device, a second command for running the debugging session within the workspace.

In Example 11, the computer-implemented method of any one of Examples 1-10 can optionally include: in response to receiving a command for creating the workspace from the device, allocating resources to create a branch of a repository storing source code of the software process.

In Example 12, the computer-implemented method of any one of Examples 1-11 can optionally include: in response to receiving a command for running the debugging session from the device, causing one or more workers in accordance with the workspace to be allocated to run the software process, and loading the core dump onto the one or more workers.

In Example 13, the computer-implemented method of any one of Examples 1-12 can optionally include: in response to receiving a command for running the debugging session from the device, causing resources to run a code editor to be allocated.

In Example 14, the computer-implemented method of any one of Examples 1-13 can optionally include: in response to receiving a command for running the debugging session from the device, causing resources to run a debugger to be allocated.

In Example 15, the computer-implemented method of any one of Examples 1-14 can optionally include: in response to resources being successfully allocated to create the workspace and run the debugging session, transmitting a ready-status message to the device.

In Example 16, the computer-implemented method of any one of Examples 1-15 can optionally include: in response to receiving a command to delete the workspace from the device, recycling resources allocated to the workspace.

Example 17 is a computer-implemented method for deferring creation of a debugging session, comprising: receiving a uniform resource identifier encoding information for creating a workspace and running a debugging session within the workspace to debug a failure that occurred with a software process; parsing, by a uniform resource identifier handler, the uniform resource identifier to extract values; translating, by the uniform resource identifier handler, the values into one or more commands to create and run the debugging session; inputting the one or more commands into an interface; and causing the interface to execute the one or more commands.

In Example 18, the computer-implemented method of Example 17 can optionally include: receiving user input on a user device selecting the uniform resource identifier.

In Example 19, the computer-implemented method of Example 17 or 18 can optionally include: receiving the uniform resource identifier from a user via a user interface.

In Example 20, the computer-implemented method of any one of Examples 17-19 can optionally include: in response to receiving the uniform resource identifier, running the interface suitable for executing the one or more commands on a user device.

In Example 21, the computer-implemented method of any one of Examples 17-20 can optionally include: the uniform resource identifier comprising information for creating the workspace, and the information for creating the workspace comprising information identifying a repository storing source code of the software process.

In Example 22, the computer-implemented method of any one of Examples 17-21 can optionally include: the uniform resource identifier comprising a command for running the debugging session within the workspace.

In Example 23, the computer-implemented method of Example 22 can optionally include: the command comprising a sub-command to run the debugging session within the workspace.

In Example 24, the computer-implemented method of Example 22 or 23 can optionally include: the command comprising a sub-command to load a core dump stored at a storage location specified in the uniform resource identifier into the workspace.

In Example 25, the computer-implemented method of any one of Examples 17-24 can optionally include: the uniform resource identifier comprising a name identifying the workspace.

In Example 26, the computer-implemented method of any one of Examples 17-25 can optionally include: receiving a ready-status message indicating that resources have been successfully allocated for the workspace and to run the debugging session.

In Example 27, the computer-implemented method of any one of Examples 17-26 can optionally include: receiving user input on a user device to delete the workspace to cause resources allocated for the workspace and the debugging session to be recycled.

In Example 28, the computer-implemented method of any one of Examples 17-27 can optionally include: in response to the interface executing the one or more commands, causing an output of a user device to display a user interface of a code editor.

In Example 29, the computer-implemented method of any one of Examples 17-28 can optionally include: in response to the interface executing the one or more commands, causing an output of a user device to display a user interface of a debugger.

In Example 30, the computer-implemented method of Example 29 can optionally include: the user interface of the debugger indicating a position in a source code of the software process where the failure occurred.

Example 31 is a computing system for deferring creation of a debugging session, comprising: one or more processors; one or more storage devices to store instructions executable by the one or more processors; a software process encoded in the instructions; and a monitor encoded in the instructions to: in response to a failure being detected for a software process, determine information relating to the software process encountering the failure; translate the information relating to the software process into a uniform resource identifier, wherein the uniform resource identifier encodes information for creating a workspace and a debugging session within the workspace in a string format; and transmit the uniform resource identifier to a device, wherein the device has a uniform resource identifier handler and an interface to create the workspace and run the debugging session using the information encoded in the uniform resource identifier.

In Example 32, the computing system of Example 31 can optionally include features in any one of Examples 1-16.

Example 33 is a computing system for deferring creation of a debugging session, comprising: one or more processors; one or more storage devices to store instructions executable by the one or more processors; an interface encoded in the instructions; and a uniform resource identifier handler encoded in the instructions to: receive a uniform resource identifier encoding information for creating a workspace and running a debugging session within the workspace to debug a failure that occurred with a software process; parse the uniform resource identifier to extract values; translate the values into one or more commands to create and run the debugging session; and input the one or more commands into the interface to cause the interface to execute the one or more commands.

In Example 33, the computing system of Example 31 can optionally include features in any one of Examples 17-30.

Example A has one or more non-transitory computer-readable medium having instructions stored thereon, that when executed by one or more processors, cause the one or more processors to perform any one of the computer-implemented methods in Examples 1-30.

Example B is an apparatus comprising means to carry out or perform any one of the computer-implemented methods in Examples 1-30.

What is claimed is:

1. A computer-implemented method for deferring creation of a debugging session, comprising:
in response to a failure being detected for a software process, determining information relating to the software process encountering the failure, wherein the information relating to the software process includes:
information specifying a workspace that is to be used for debugging the software process; and
a storage location in which a core dump of an environment executing the software process is stored;
transforming the information relating to the software process into a uniform resource identifier, wherein the uniform resource identifier encodes information for creating the debugging session in a string format; and
transmitting the uniform resource identifier to a device, wherein the device has a uniform resource identifier handler and an interface to create the workspace and run the debugging session using the information encoded in the uniform resource identifier.

2. The computer-implemented method of claim 1, wherein:
the uniform resource identifier comprises information for creating the workspace; and
the information for creating the workspace comprises information identifying a repository storing source code of the software process.

3. The computer-implemented method of claim 1, wherein the uniform resource identifier comprises:
a command for running the debugging session within the workspace.

4. The computer-implemented method of claim 3, wherein the command comprises:
a sub-command to run the debugging session within the workspace.

5. The computer-implemented method of claim 4, wherein the command comprises:
a sub-command to load the core dump stored at the storage location into the workspace.

6. The computer-implemented method of claim 1, wherein the uniform resource identifier comprises:
a name identifying the workspace.

7. The computer-implemented method of claim 1, further comprising:
receiving, from the device, a first command for creating the workspace; and
receiving, from the device, a second command for running the debugging session within the workspace.

8. The computer-implemented method of claim 1, further comprising:
in response to receiving a command for creating the workspace from the device, allocating resources to create a branch of a repository storing source code of the software process.

9. The computer-implemented method of claim 1, further comprising:
in response to receiving a command for running the debugging session from the device, causing one or more workers in accordance with the workspace to be allocated to run the software process, and loading the core dump onto the one or more workers.

10. The computer-implemented method of claim 1, further comprising:
in response to receiving a command for running the debugging session from the device, causing resources to run a code editor to be allocated.

11. The computer-implemented method of claim 1, further comprising:
in response to receiving a command for running the debugging session from the device, causing resources to run a debugger to be allocated.

12. The computer-implemented method of claim 1, further comprising:
in response to resources being successfully allocated to create the workspace and run the debugging session, transmitting a ready-status message to the device.

13. The computer-implemented method of claim 1, further comprising:
in response to receiving a command to delete the workspace from the device, recycling resources allocated to the workspace.

14. A computer-implemented method for deferring creation of a debugging session, comprising:
receiving a uniform resource identifier encoding information for creating a workspace and running a debugging session within the workspace to debug a failure that occurred with a software process;
parsing, by a uniform resource identifier handler, the uniform resource identifier to extract values;
translating, by the uniform resource identifier handler, the values into one or more commands to create and run the debugging session;
inputting the one or more commands into an interface; and
causing the interface to execute the one or more commands.

15. The computer-implemented method of claim 14, further comprising:
receiving user input on a user device selecting the uniform resource identifier.

16. The computer-implemented method of claim 14, further comprising:
receiving the uniform resource identifier from a user via a user interface.

17. The computer-implemented method of claim 14, further comprising:
in response to receiving the uniform resource identifier, running the interface suitable for executing the one or more commands on a user device.

18. The computer-implemented method of claim 17, further comprising:
receiving a ready-status message indicating that resources have been successfully allocated for the workspace and to run the debugging session.

19. The computer-implemented method of claim 17, further comprising:
in response to the interface executing the one or more commands, causing an output of a user device to display a user interface of a code editor and a user interface of a debugger, wherein the user interface of the debugger indicates a position in a source code of the software process where the failure occurred.

20. A computing system for deferring creation of a debugging session, comprising:
one or more processors;
one or more storage devices to store instructions executable by the one or more processors;
a software process encoded in the instructions; and
a monitor encoded in the instructions to:
in response to a failure being detected for a software process, determine information relating to the software process encountering the failure;
translate the information relating to the software process into a uniform resource identifier, wherein the uniform resource identifier encodes information for creating a workspace and a debugging session within the workspace in a string format; and
transmit the uniform resource identifier to a device, wherein the device has a uniform resource identifier handler and an interface to create the workspace and run the debugging session using the information encoded in the uniform resource identifier.
